(19) United States
(12) Patent Application Publication
(10) Pub. No.: US 2025/0296478 A1
(43) Pub. Date: Sep. 25, 2025

(54) TEMPERATURE ADJUSTMENT SYSTEM

(71) Applicant: TOYOTA JIDOSHA KABUSHIKI KAISHA, Toyota-shi (JP)

(72) Inventor: Hirotaka Sasaki, Nagoya-shi (JP)

(73) Assignee: TOYOTA JIDOSHA KABUSHIKI KAISHA, Toyota-shi (JP)

(21) Appl. No.: 19/006,405

(22) Filed: Dec. 31, 2024

(30) Foreign Application Priority Data
Mar. 25, 2024 (JP) 2024-047603

(51) Int. Cl. B60L 58/27; B60L 58/26

(52) U.S. Cl. CPC B60L 58/27; B60L 58/26; B60L 2240/545; B60L 2260/56; B60L 2260/58

(57) ABSTRACT

A temperature adjustment system includes a control device. The control device is configured to control a temperature adjustment device that adjusts a temperature of a power storage device mounted in a vehicle. The control device is configured to acquire charging schedule information related to a schedule of external charging of the power storage device. The control device is configured to execute a first precondition control that controls the temperature adjustment device such that a temperature of the power storage device is brought close to a target temperature before a start of traveling of the vehicle. The target temperature in the first precondition control is different when the external charging of the power storage device is scheduled and when the external charging of the power storage device is not scheduled.

### CROSS-REFERENCE TO RELATED APPLICATION

This application claims priority to Japanese Patent Application No. 2024-047603 filed on Mar. 25, 2024, incorporated herein by reference in its entirety.

### BACKGROUND

### 1. Technical Field

The present disclosure relates to a temperature adjustment system that adjusts the temperature of a power storage device mounted in a vehicle.

### 2. Description of Related Art

Japanese Unexamined Patent Application Publication No. 2019-046737 (JP 2019-046737 A) discloses a vehicle including a power storage device and a heater that heats the power storage device. The vehicle is configured to execute external charging of the power storage device. Also, the vehicle heats the power storage device by the heater, during the external charging of the power storage device, and after completion of the external charging, the vehicle determines whether or not to stop the heater based on a departure schedule time (traveling start schedule time) of the vehicle.

### SUMMARY

In the vehicle described in JP 2019-046737 A, the power storage device becomes a preferable temperature at a start of traveling of the vehicle, by controlling the temperature of the power storage device after completion of the external charging and before a start of traveling of the vehicle. Namely, in the vehicle described in JP 2019-046737 A, a pre-temperature adjustment (precondition control) is executed for the power storage device in order to start traveling. However, the preferable temperature of the power storage device at a start of traveling of the vehicle is not necessarily uniform. The preferable temperature of the power storage device at a start of traveling of the vehicle may vary in accordance with the state and schedule of the vehicle.

The present disclosure provides a temperature adjustment system that can adjust a temperature of a power storage device mounted in a vehicle to an appropriate temperature in accordance with a state and/or schedule of the vehicle.

According to the present disclosure, a temperature adjustment system that includes a control device is provided. The control device is configured to control a temperature adjustment device that adjusts a temperature of a power storage device mounted in a vehicle.

The control device is configured to acquire charging schedule information related to a schedule of external charging of the power storage device.

The control device is configured to execute a first precondition control that controls the temperature adjustment device such that a temperature of the power storage device is brought close to a target temperature before a start of traveling of the vehicle.

The target temperature in the first precondition control is different when the external charging of the power storage device is scheduled and when the external charging of the power storage device is not scheduled.

In the vehicle, a preferable temperature of the power storage device at a start of traveling of the vehicle is different when the external charging of the power storage device (namely, charging of the power storage device by power from outside of the vehicle) is scheduled and when the external charging of the power storage device is not scheduled. The first precondition control enables the temperature of the power storage device to be adjusted in accordance with a schedule of the vehicle (the presence or absence of external charging) before a start of traveling of the vehicle (for example, before boarding). Accordingly, the temperature adjustment system can adjust the temperature of the power storage device to an appropriate temperature in accordance with a schedule of the vehicle.

The functions of the control device may be realized by only hardware (for example, an electronic circuit), or may be realized by using software. The control device may be a single unit or may be formed from a plurality of units. The control device may include a plurality of processors mounted in separate units and a plurality of storage devices mounted in separate units.

According to the present disclosure, a temperature adjustment system can be provided that can adjust a temperature of a power storage device mounted in a vehicle to an appropriate temperature in accordance with a state and/or schedule of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of a temperature adjustment system according to an embodiment of the present disclosure;

FIG. 2 is a flowchart illustrating a process flow related to the condition setting of the temperature adjustment control (battery temperature adjustment control) according to the present embodiment;

FIG. 3 is a diagram for explaining functions of each of the control device and the mobile terminal in the temperature adjustment system shown in FIG. 1;

FIG. 4 is a flowchart showing a procedure of the battery temperature control according to the present embodiment;

FIG. 5 is a diagram illustrating a modification of a process for inputting an external charging; and

FIG. 6 is a diagram illustrating a modification of the condition setting method of the precondition control.

### DETAILED DESCRIPTION OF EMBODIMENTS

Embodiments of the present disclosure will be described in detail with reference to the drawings. The same or corresponding parts in the drawings are designated by the same reference signs and repetitive description will be omitted.

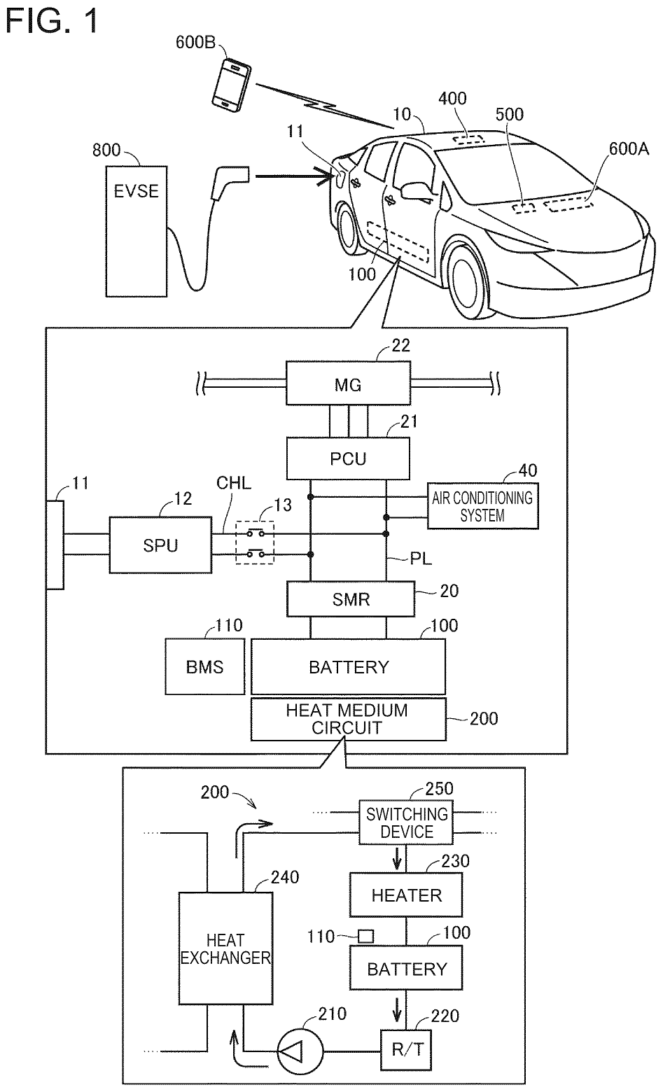

FIG. 1 is a diagram illustrating a configuration of a vehicle equipped with a temperature adjustment system according to the embodiment. Referring to FIG. 1, the vehicle 10 includes an inlet 11, a Smart Power Unit (SPU) 12, a charge relay 13, a System Main Relay (SMR) 20, and a Power Control Unit (PCU) 21. Further, the vehicle 10 includes a Motor Generator (MG) 22, an air conditioner 40, a battery 100, a heat medium circuit 200, a communication device 400, an Electronic Control Unit (ECU) 500, and a Human Machine Interface (HMI) 600A. ECU 500 corresponds to an exemplary “control device” according to the present disclosure.

The vehicle 10 is configured to be able to travel using electric power output from the battery 100. The battery 100 may include a secondary battery such as a lithium-ion battery. The type of the secondary battery may be a liquid secondary battery or an all-solid secondary battery. A plurality of secondary batteries may form a battery pack. Instead of the secondary battery, another power storage device (for example, an electric double layer capacitor) may be employed. The vehicles 10 are, for example, battery electric vehicle (BEV) without internal combustion engines. However, the present disclosure is not limited thereto, and the vehicles 10 may be plug-in hybrid electric vehicle (PHEV) equipped with an internal combustion engine, or may be another electrified vehicle (xEV).

SMR 20 is a relay located between the battery 100 and PCU 21. MG 22 functions as a driving motor and rotates the driving wheels of the vehicles 10. PCU 21 drives MG 22 using the electric power supplied from the battery 100. PCU 21 includes inverters, for example. MG 22 converts power into torques. Torque is transmitted to the drive wheels. In addition, MG 22 performs regenerative power generation, for example, at the time of deceleration of the vehicle 10, and charges the battery 100.

The battery 100 is provided with a Battery Management System (BMS) 110 for monitoring the status of the battery 100. BMS 110 includes various sensors that detect the status (e.g., voltage, current, and temperature) of the battery 100, and outputs the detected data to ECU 500. BMS 110 may further include at least one of a State Of Charge (SOC) estimation function and a State of Health (SOH) estimation function in addition to the sensor function.

ECU 500 acquires a detected value from various sensors mounted on the vehicle 10, and controls various devices mounted on the vehicle 10. The various sensors are a BMS 110, a position sensor (not shown), a vehicle speed sensor, an outside air temperature sensor, and the like. For various equipment. SPU 12, the charge relays 13, SMR 20, PCU 21, the air conditioner 40, and the devices included in the heat medium circuit 200, which will be described later. Various devices mounted on the vehicle 10 are directly or indirectly supplied with electric power from the battery 100. For example, the devices (e.g., PCU 21 and air conditioner 40) connected to the high voltage power supply line PL are directly powered by the battery 100. In addition, a low-voltage on-board device (for example, auxiliary devices) receives power from a low-voltage battery (for example, auxiliary battery) having a voltage lower than that of the battery 100. When SOC of the low-voltage battery decreases, electric power is supplied from the battery 100 to the low-voltage battery.

The heat medium circuit 200 includes a flow path through which the heat medium flows. The flow path of the heat medium circuit 200 is provided so that the heat medium flowing through the flow path exchanges heat with the battery 100. The heat medium circuit 200 is configured to adjust the temperature of the battery 100 using the power output from the battery 100. Specifically, the heat medium circuit 200 further includes a pump 210, a reserve tank (R/T) 220, heaters 230, a heat exchanger 240 and a switching device 250. The pump 210 circulates the heat medium in the flow path of the heat medium circuit 200. The heater 230 heats the heat medium flowing in the flow path of the heat medium circuit 200. However, the heater 230 may be provided to directly heat the battery 100.

A flow path of the heat medium circuit 200 is connected to a flow path of another heat medium circuit (hereinafter, referred to as a “first heat medium circuit”) via the heat exchanger 240. The heat exchanger 240 may be a chiller or a condenser. The first heat medium circuit includes, for example, a cooling circuit (refrigeration cycle circuit) of the air conditioner 40. The heat exchanger 240 performs heat exchange between the heat medium flowing through the flow path of the heat medium circuit 200 and the heat medium flowing through the flow path of the first heat medium circuit. ECU 500 can adjust the temperature of the heat medium flowing through the flow path of the heat medium circuit 200 (and thus the temperature of the battery 100) by controlling the air conditioner 40.

Further, the flow path of the heat medium circuit 200 is connected to the flow path of each of the plurality of heat medium circuits (hereinafter, referred to as “second heat medium circuits”) via the switching device 250. The switching device 250 is, for example, a five-way valve. The plurality of second heat medium circuits may include at least one of a circuit in which the heat medium circulates so as to cool at least one of SPU 12, PCU 21 and MG 22, and a circuit in which the heat medium circulates so as to be cooled by the radiator. In response to an instruction from ECU 500, the switching device 250 connects the flow path of the heat medium circuit 200 to any one of the plurality of second heat medium circuits, or disconnects the flow path from each of the plurality of second heat medium circuits. ECU 500 can increase the temperature of the heat medium flowing through the flow path of the heat medium circuit 200 and heat the battery 100 by connecting the flow path of the heat medium circuit 200 to the flow path of the second heat medium circuit through which the high-temperature heat medium flows. Further, ECU 500 can cool the battery 100 by connecting the flow path of the heat medium circuit 200 to the flow path of the second heat medium circuit through which the low-temperature heat medium flows, thereby reducing the temperature of the heat medium flowing through the flow path of the heat medium circuit 200.

As the heat medium flowing through each heat medium circuit, a known heat medium can be employed. For example, the heat medium flowing through the flow path of the heat medium circuit 200 may be water, insulating oil, or Long Life Coolant (LLC). However, the present disclosure is not limited thereto, and for example, a chlorofluorocarbon refrigerant, carbon dioxide gas, propane gas, or the like may be employed as the heat medium. Instead of the five-way valve, other multi-way valves (for example, a six-way valve, a seven-way valve, an eight-way valve, a nine-way valve, or a ten-way valve) may be employed as the switching device 250. The switching device 250 may be configured by a plurality of multi-way valves.

In this embodiment, the air conditioner 40 and the heat medium circuit 200 function as an example of a “temperature adjustment device” according to the present disclosure. However, the heating method and the cooling method of the battery 100 are arbitrary. For example, the temperature of the battery 100 may be increased by using heat generated during heating of the air conditioner 40, heat generated during energization of PCU 21 (inverters), or the like.

The vehicle 10 is configured to be capable of performing external charging (charging of the battery 100 by electric power from the outside of the vehicle). SPU 12 is provided in the charge line CHL and functions as an in-vehicle charger (charging circuit). SPU 12 may function as Electric Supply Unit (ESU). The charge relay 13 switches between connecting and disconnecting the charge line CHL. ECU 500 sets the charge relay 13 to the connected state prior to starting the external charging, and maintains the charge relay 13 in the connected state during the charging to control SPU 12. Electric Vehicle Supply

Equipment (EVSE) When the leading end (connector) of the charging cable connected to 800 is connected to the inlet 11 of the parked vehicle 10 (plug-in), the vehicle 10 is electrically connected to EVSE 800. The vehicles 10 can charge the battery 100 using the electric power inputted from EVSE 800 to the inlet 11. One end of the charge line CHL is connected between SMR 20 and PCU 21, and the other end thereof is connected to the inlet 11. However, the present disclosure is not limited thereto, and one end of the charge line CHL may be connected between the battery 100 and SMR 20.

HMI 600A is an HMI (in-vehicle HMI) mounted on the vehicle 10. HMI 600A may include a touch panel display. HMI 600A may include at least one of a meter panel, a navigation system, and a head-up display.

The mobile terminal 600B is a terminal carried by a user of the vehicle 10. The mobile terminal 600B is, for example, a smart phone. A smartphone incorporates a computer including one or more processors and one or more storage devices, and includes a touch panel display and a speaker. However, the present disclosure is not limited thereto, and a laptop, a portable gaming machine, a wearable device, an electronic key, and the like can also be employed as the mobile terminal 600B.

In the vehicle 10, ECU 500 controls the air conditioner 40 and the heat medium circuit 200 to bring the temperature of the battery 100 close to the target temperature prior to starting the vehicle 10. This control corresponds to the first precondition control. ECU 500 also controls the air conditioner 40 and the heat medium circuit 200 to bring the temperature of the battery 100 closer to the target temperature during running of the vehicle 10 and prior to starting external charging of the battery 100. This control corresponds to the second precondition control. Hereinafter, “precondition control” may be referred to as “PC control”.

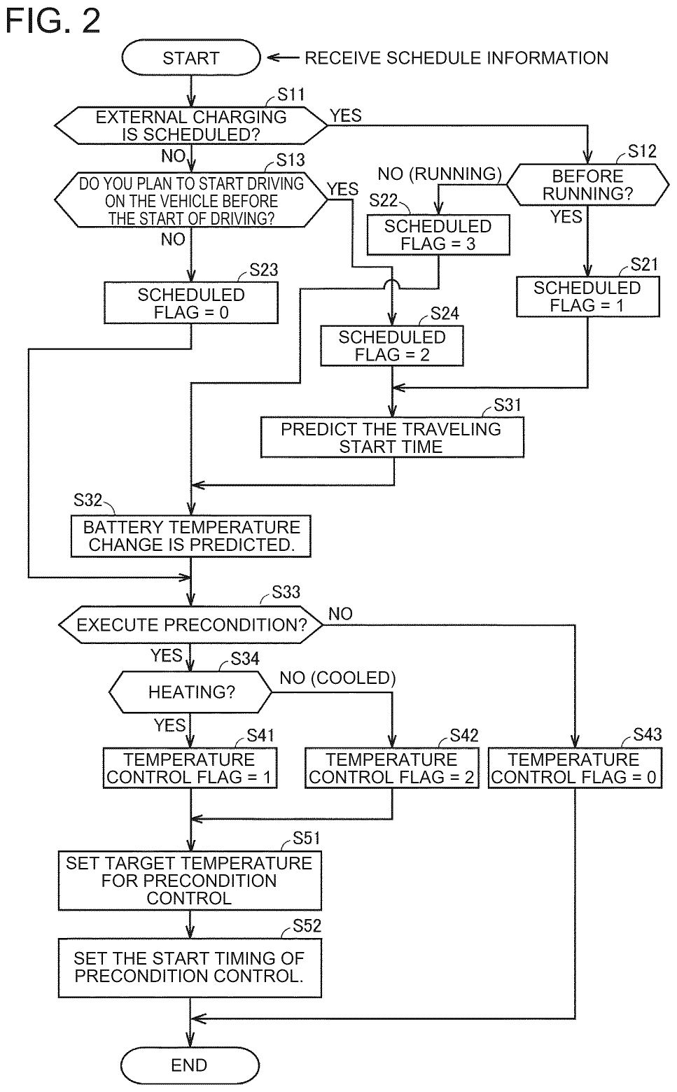

FIG. 2 is a flowchart illustrating a process of setting PC control conditions (target temperature/start timing). Note that “S” in the flowchart means a step.

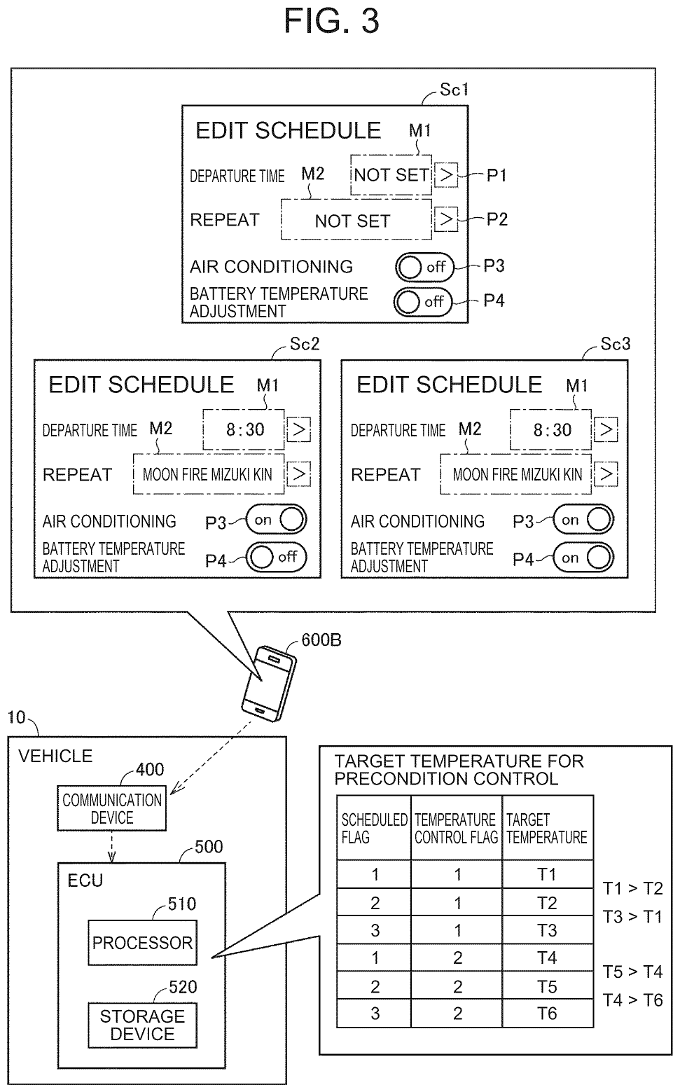

The process illustrated in FIG. 2 is started when ECU 500 acquires schedule data indicating the schedule of the vehicles 10. ECU 500 obtains the schedule from the mobile-terminal 600B. The user of the vehicle 10 can enter the schedule data into the mobile terminal 600B. FIG. 3 is a diagram for describing functions of ECU 500 and the mobile terminal 600B.

Referring to FIG. 3, ECU 500 includes a processor 510, such as a Central Processing Unit (CPU), and a storage device 520 that stores data that can be processed by the processor 510. The storage device 520 is configured to store stored information. The storage device 520 stores various kinds of information used in the program in addition to the program. When the processor 510 executes a program, various kinds of control are executed. ECU 500 also has a timer. Such a timing function may be realized by hardware (timer circuit) or may be realized by software. Further, ECU 500 performs radio communication with the mobile terminal 600B through the communication device 400.

In the mobile terminal 600B, application software (hereinafter, referred to as “scheduled application”) for managing schedules of the vehicles 10 is installed. When the scheduled application is activated in the mobile terminal 600B, for example, a screen Sc1 is displayed on the mobile terminal 600B. The mobile terminal 600B receives an input from a user.

The display Sc1 includes a display unit M1, M2 and P4 from the operation unit P1. The operation unit P1 receives a user operation for setting a scheduled departure time (traveling start schedule time) of the vehicles 10. The display unit M1 displays the scheduled departure time set by the operation unit P1. The operation unit P2 receives a user operation for setting repetition every week. The display unit M2 displays the day of the week on which repetition is set every week by the operation unit P2. The operation unit P3 receives a user operation of switching between the presence and absence of the reservation of the air conditioning. The operation unit P4 receives a user operation of switching between scheduled and unscheduled external charging.

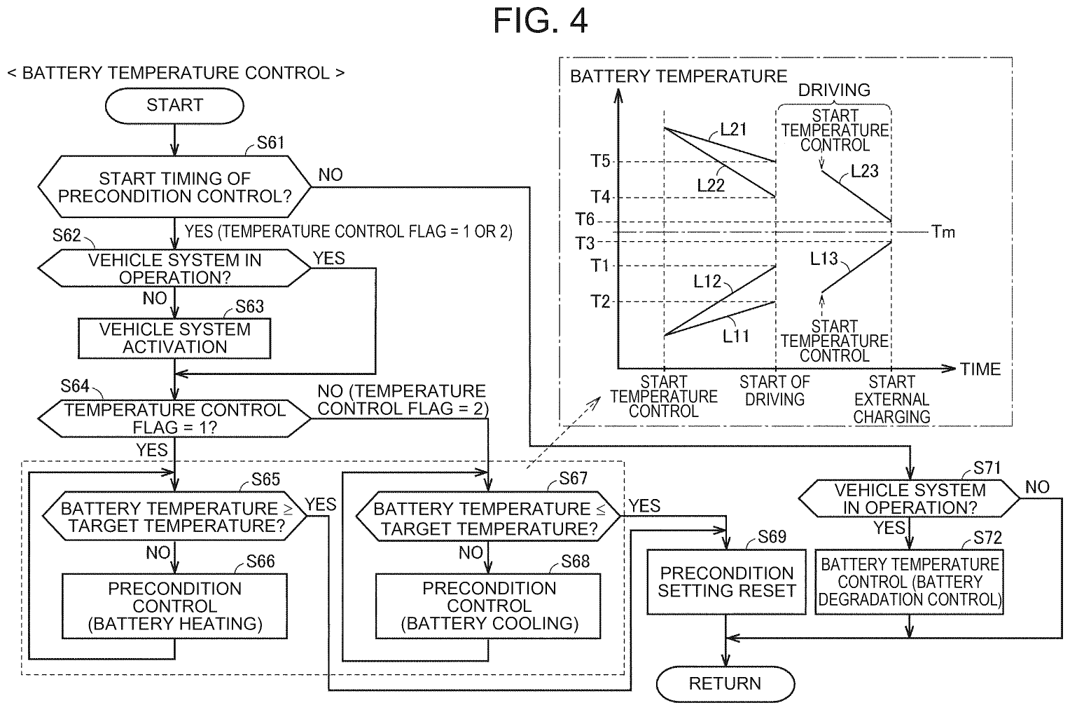

The screen Sc1 indicates that neither the scheduled departure time nor the weekly repetition is set in the scheduled application, the air conditioning is not reserved, and the external charging is not scheduled. In the scheduled application, the scheduled departure time (for example, 8:30 minutes) is set, every week repetition is set for Mon to Friday, and when the air conditioning is reserved, the mobile terminal 600B displays a screen Sc2 instead of the screen Sc1. When the weekly repetition is set, the schedule (the scheduled departure time, the presence or absence of the air-conditioning reservation, and the presence or absence of the charge schedule) associated with the designated day of the week (for example, Monday to Friday) is stored in the storage device of the mobile terminal 600B. Then, each time the designated day of the week is reached, the mobile terminal 600B reads the schedule associated with the day of the week from the storage device and automatically sets the schedule. Further, the user can request the ECU 500 to perform PC control (refer to S66, S68 of FIG. 4 described later) for air-conditioning in the vehicle cabin of the vehicle 10 by reserving the air-conditioning through the scheduled application.

In the scheduled application, when the external charging is set to be scheduled, the mobile terminal 600B displays a screen Sc3 instead of the screen Sc2. The scheduled external charging is an external charging at a location other than the current location. The scheduled external charging means that the vehicles 10 move toward EVSE. By inputting the schedule of external charging through the scheduled application, the user can request the ECU 500 to adjust the temperature of the battery 100 in advance for external charging (see S66, S68 of FIG. 4 described later).

When the schedule of the vehicle 10 is newly set by the user or the schedule of the vehicle 10 is changed, or when the schedule of the vehicle 10 is automatically set based on the weekly repetition setting by the user, the schedule information is transmitted from the mobile terminal 600B to ECU 500. The schedule information indicates a schedule of the vehicle 10 set by the user through the aforementioned schedule application. Specifically, the schedule information includes charging schedule information indicating whether or not there is a schedule for external charging and air-conditioning reservation information indicating whether or not there is a reservation for air-conditioning. When the scheduled departure time is set, the scheduled departure time information further includes departure time information indicating the scheduled departure time. When the scheduled departure time is not set in the scheduled application, the scheduled setting of the reservation of the air conditioning and/or the scheduled setting of the external charging may be prohibited.

ECU 500 starts the process illustrated in FIG. 2 each time the schedule data of the day is received from the mobile terminal 600B. When ECU 500 receives the schedule data in a stopped state (for example, a sleep state), it starts up and starts the process flow. Referring to FIG. 2, in S11, ECU 500 determines whether or not external charging is scheduled based on the charging schedule information. When the external charging is scheduled (YES in S11), ECU 500 determines, in S12, whether or not the vehicle 10 is in a pre-running condition. ECU 500 may, for example, determine that the vehicle driving device (PCU 21 and MG 22) for rotating the driving wheels of the vehicle 10 using the electric power is prior to starting running when it is in a stopped state (inactive), and it may be determined that the running of the vehicle 10 is started when the vehicle driving device is in an operating state (active). ECU 500 may determine whether the vehicle 10 is in a pre-running state or in a running state based on the state (disconnection and connection) of each of the charge relay 13 and SMR 20. In this embodiment, power is supplied to the vehicle drive when SMR 20 is connected. When the charge relay 13 is in the shut-off state, the vehicle driving device is in the operating state. However, when the charge relay 13 is in the connected state, the vehicle driving device is in the stopped state, and the traveling of the vehicle 10 is prohibited. ECU 500 starts or stops the control system (vehicle system) of the vehicle 10 in response to a start operation or a stop operation by the user, or when a predetermined start condition or stop condition is satisfied. When the vehicle-system is stopped, the charge relay 13 and SMR 20 are shut off. After activation of the vehicle-system (including the ECU 500), SMR 20 is connected by ECU 500. In addition, ECU 500 sets the charge relay 13 to the connected state after stopping the vehicle-driven device in response to a request for external charging from the user or EVSE.

When it is determined that the vehicle 10 has not started traveling (YES in S12), ECU 500 sets “1” in the schedule flag stored in the storage device 520 in S21. Thereafter, the process proceeds to S31. On the other hand, when it is determined that the vehicle 10 is traveling (NO in S12), ECU 500 sets the scheduled flag to “3” in S22. Thereafter, the process proceeds to S32.

When the external charging is not scheduled (NO in S11), ECU 500 determines whether or not the vehicles 10 are scheduled to begin traveling in S13. ECU 500 determines whether or not the vehicle 10 is scheduled to begin traveling based on the schedule information. When the schedule information indicates the scheduled departure time or the scheduled air-conditioning for the vehicle 10, it means that the vehicle 10 is scheduled to start traveling. When neither the scheduled departure time nor the reservation of the air conditioning exists for the vehicles 10, it is determined that S13 is NO. Also, when the vehicles 10 are traveling, it is determined that S13 is NO. If NO is determined in S13, ECU 500 sets the scheduled flag to “0” in S23. Thereafter, the process proceeds to S33. On the other hand, when the vehicle 10 is in a condition prior to the start of traveling and the vehicle 10 is scheduled to start traveling (YES in S13), ECU 500 sets the schedule flag to “2” in S24. Thereafter, the process proceeds to S31.

In S31, ECU 500 predicts the traveling start time of the vehicles 10 using the schedule information (traveling schedule information). When the schedule information includes the departure time information, ECU 500 predicts that the vehicle 10 starts traveling at the departure time indicated by the departure time information. When the schedule information does not include the departure time information and indicates that the air conditioning is reserved, ECU 500 may predict the time at which a predetermined time has elapsed from the timing at which the air conditioning is reserved from the absence of the air conditioning reservation to the presence of the air conditioning reservation as the traveling start time of the vehicle 10. When the schedule information does not include the departure time information and indicates that the external charging is scheduled, ECU 500 may predict a time at which a predetermined time has elapsed from a timing at which the charging schedule is switched from the absence of the charging schedule to the presence of the charging schedule as the traveling starting time of the vehicle 10. When the traveling start time is predicted in S31, the process proceeds to S32.

In S32, ECU 500 acquires the present temperature of the battery 100 and predicts a transition (temperature change) of the temperature of the battery 100 in the future. ECU 500 may predict a temperature change of the battery 100 prior to starting the traveling based on the outside air temperature. ECU 500 may predict a temperature change of the battery 100 during traveling based on the outside air temperature and the traveling condition.

In S33, ECU 500 determines whether to perform PC control. If the scheduled flag is “0”, a non-execution determination is made (NO in S33), and the process proceeds to S43. On the other hand, when the scheduled flag is “1” or “2”, ECU 500 determines non-execution and execution of PC control based on the success or failure of the predetermined prohibition condition. When the prohibition condition is satisfied, it is determined that S33 is NO, and the process proceeds to S43. For example, when the present SOC of the battery 100 is equal to or less than the predetermined value, the prohibition condition may be satisfied. In addition, when S32 process predicts that the temperature of the battery 100 is included in the reference temperature (for example, Tm in FIG. 4 to be described later) or a temperature in the vicinity thereof (the recommended temperature range) without executing PC control, the prohibition condition may be satisfied. In S43, ECU 500 sets the temperature control flag stored in the storage device 520 to “0”. Thereafter, the process flow ends.

When the scheduled flag is “1” or “2” and the prohibition condition is not satisfied, the execution is determined (YES in S33), and the process proceeds to S34. In S34, ECU 500 determines whether or not to heat the battery 100 by PC control to be executed. ECU 500 determines, for example, whether heating or cooling is required in order to place the temperature of the battery 100 in the recommended temperature range based on the transition of the temperature of the battery 100 predicted by S32. When the battery 100 is heated by PC control (YES in S34), ECU 500 sets the temperature control flag to “1” in S41. When the battery 100 is cooled by PC control (NO in S34), ECU 500 sets the temperature control flag to “2” in S42.

When “1” or “2” is set in the temperature control flag, the process proceeds to S51. In S51, ECU 500 sets a target temperature in PC control. In this embodiment, ECU 500 sets the target temperature based on the table shown in FIG. 3. Specifically, when the vehicle 10 is not running and external charging is scheduled and the battery 100 is heated by PC control (scheduled flag=“1” and temperature control flag=“1”), ECU 500 sets the first temperature (hereinafter, referred to as “T1”) to the target temperature. When the vehicle 10 is not running and the vehicle 10 is scheduled to travel and is not scheduled to be external charging and the battery 100 is heated by PC control (scheduled flag =“2” and temperature control flag =“1”), ECU 500 sets the second temperature (hereinafter, referred to as “T2”) to the target temperature. When the vehicle 10 is running and external charging is scheduled and the battery 100 is heated by PC control (scheduled flag =“3” and temperature control flag =“1”), ECU 500 sets a third temperature (hereinafter referred to as “T3”) to the target temperature. When the vehicle 10 is not running and external charging is scheduled and the battery 100 is cooled by PC control (scheduled flag =“1” and temperature control flag =“2”), ECU 500 sets a fourth temperature (hereinafter referred to as “T4”) to the target temperature. When the vehicle 10 has not started traveling and the vehicle 10 is scheduled to travel and is not scheduled to be external charging and the battery 100 is cooled by PC control (scheduled flag =“2” and temperature control flag =“2”), ECU 500 sets a fifth temperature (hereinafter, referred to as “T5”) to the target temperature. When the vehicle 10 is running and external charging is scheduled and the battery 100 is cooled by PC control (scheduled flag =“3” and temperature control flag =“2”), ECU 500 sets a sixth temperature (hereinafter referred to as “T6”) to the target temperature. For T1 to T6, T1 is higher than T2, T3 is higher than T1, T5 is higher than T4, and T4 is higher than T6. By setting the target temperature in PC control as described above, the temperature of the battery 100 can be easily adjusted to an appropriate temperature according to the state and schedule of the vehicles 10.

When the target temperature is set in S51, ECU 500 sets the starting timing of PC control in S52. When the vehicle 10 is in a state prior to the start of traveling, ECU 500 determines the start timing of PC control using the traveling start time predicted by S31. ECU 500 determines the start timing of PC control so that the temperature of the battery 100 reaches the target temperature at or immediately before the predicted traveling start time. On the other hand, when the vehicle 10 is traveling, ECU 500 determines a timing (for example, after a few minutes) at which a predetermined time has elapsed from the current time or the current time as a starting timing of PC control. As a result, the processing flow illustrated in FIG. 2 ends. When the vehicle 10 is in a state prior to the start of traveling, ECU 500 may set the start timing of PC control determined by S52 as the start timing to the timer, and then enter a stop state (for example, a sleep state).

FIG. 4 is a flow chart showing a sequence of battery temperature control including a first PC control and a second PC control. Referring to FIG. 4, in S61, it is determined whether or not PC control set in S52 of FIG. 2 is started. When the temperature control flag is “0”, since S52 process is not executed, it is determined as NO in S61, and the process proceeds to S71. Also, when the set starting timing is not reached (NO in S61), the process proceeds to S71.

In S71, it is determined whether the vehicle-system is in operation. When the vehicle 10 is in a state before the start of traveling, basically, the vehicle system is in a stopped state (including a sleep state). However, even prior to the beginning of travel, the vehicle-system may be activated by S63 process described below. When the vehicle-system is stopped (NO in S71), the process returns to the first step (S61). Therefore, S61, S71 processes are repeated while the set start timing does not arrive prior to the start of the traveling of the vehicles 10. On the other hand, when the vehicle 10 is traveling, the vehicle is operating (YES in S71), and the process proceeds to S72. In S72, ECU 500 executes predetermined battery temperature control. Specifically, ECU 500 controls the air conditioner 40 and the heat medium circuit 200 so that air-conditioning requirements from the user are satisfied and degradation of the battery 100 is suppressed. Thereafter, the process returns to S61. Therefore, when PC control starting timing is not set, S61, S71, S72 processes are repeated while the vehicles 10 are traveling. The steps in FIG. 4 are performed by ECU 500 while traveling.

When the timing of starting the set PC control arrives (YES in S61), S62 determines whether the vehicle-system is in operation. If the vehicle is in operation (YES in S62), the process proceeds to S64. When the vehicle system is stopped (NO in S62), the process proceeds to S64 after the vehicle system (including the ECU 500) is started in S63. S61 is determined to be NO while the timer set in the stopped ECU 500 does not arrive. When the start timing set in the timer of the stopped ECU 500 arrives, S61 determines YES and S62 determines NO, and S63 may activate the ECU 500 (including the processor 510) by the timer.

In S64, ECU 500 determines whether or not the temperature control flag is “1”. When the temperature control flag is “1” (YES in S64), ECU 500 determines whether or not the temperature of the battery 100 is equal to or higher than the target temperature (any of T3 from T1 set in S51 of FIG. 2) in S65. If the temperature of the battery 100 is less than the target temperature, ECU 500 heats the battery 100 by S66 by the first PC control or the second PC control. Specifically, ECU 500 controls the air conditioner 40 and the heat medium circuit 200 to bring the temperature of the battery 100 closer to the target temperature. When the air-conditioning is reserved, the air conditioner 40 is further controlled so that the temperature in the vehicle cabin approaches a predetermined temperature. While the temperature of the battery 100 does not reach the target temperature (NO in S65), S65, S66 is repeated and PC control is continued. Then, when the temperature of the battery 100 reaches the target temperature by PC control (S66), the process proceeds to S69. As a result, PC control ends.

When the temperature control flag is “2” (NO in S64), ECU 500 determines whether or not the temperature of the battery 100 is equal to or lower than the target temperature (any of T6 from T4 set in S51 of FIG. 2) in S67. When the temperature of the battery 100 is higher than the target temperature, ECU 500 cools the battery 100 by S68 by the first PC control or the second PC control. Specifically, ECU 500 controls the air conditioner 40 and the heat medium circuit 200 to bring the temperature of the battery 100 closer to the target temperature. When the air-conditioning is reserved, the air conditioner 40 is further controlled so that the temperature in the vehicle cabin approaches a predetermined temperature. While the temperature of the battery 100 does not reach the target temperature (NO in S67), S67, S68 is repeated and PC control is continued. Then, when the temperature of the battery 100 reaches the target temperature by PC control (S68), the process proceeds to S69. As a result, PC control ends.

In S69, ECU 500 resets (e.g., reverts to no setting) PC control criteria (target temperature and starting timings). Then, the process returns to S61. Thus, S61 is determined to be NO, S61, S71, S72 processes are repeated, and the battery temperature control of S72 is continued. When the air conditioning is reserved, the temperature in the vehicle cabin is maintained at a predetermined temperature (for example, a comfortable temperature) by the battery temperature control of S72.

The line L11, line L12, line L13, line L21, line L22, and line L23 in FIG. 4 show the temperature transition of the battery 100 during PC control (S66 or S68) where T2, T1, T3, T5, T4, T6 is set as the target temperature, respectively.

The temperature range of the battery 100 required at the start of traveling of the vehicle 10 (the recommended temperature range at the start of traveling) tends to be wider than the temperature range of the power storage device required at the start of external charging (the recommended temperature range at the start of external charging). All T1 to T6 are included in the recommended temperature-range at the beginning of the run. Each of T3, T6 is also included in the recommended temperature-range at the time of starting the external charging. T6 is higher than T3. Tm corresponds to a reference temperature (for example, a recommended temperature at the beginning of external charging). When the temperature of the battery 100 is included in the recommended temperature range at the start of the external charging at the start of the external charging, the external charging is likely to be easily supplied with a large amount of power (rapid charging) from EVSE.

In the first PC control (S68) for cooling the battery 100, the temperature of the battery 100 changes as indicated by the line L21, L22. The target temperature (T5) when external charging is not scheduled is higher than the target temperature (T4) when external charging is scheduled. When the external charging is not scheduled, the power dissipation of the battery 100 can be suppressed by quickly terminating the cooling of the battery 100 by the first PC control. This makes it easier to leave a sufficient amount of electricity stored in the battery 100 for traveling. In addition, if the battery 100 is cooled until the temperature of the battery 100 becomes T5, the traveling of the vehicles 10 is less likely to be adversely affected. On the other hand, when external charging is scheduled, the battery 100 is cooled to T4 by the first PC control, so that the temperature of the battery 100 approaches the recommended temperature range at the time of starting external charging.

In the first PC control (S66) for heating the battery 100, the temperature of the battery 100 transitions as indicated by the lines L11, L12. The target temperature (T2) when external charging is not scheduled is lower than the target temperature (T1) when external charging is scheduled. When the external charging is not scheduled, the power dissipation of the battery 100 can be suppressed by quickly ending the heating of the battery 100 by the first PC control. This makes it easier to leave a sufficient amount of electricity stored in the battery 100 for traveling. Further, if the battery 100 is heated until the temperature of the battery 100 becomes T2, the traveling of the vehicles 10 is less likely to be adversely affected. On the other hand, when the external charging is scheduled, the temperature of the battery 100 approaches the recommended temperature range at the time of starting the external charging by the battery 100 being heated to T1 by the first PC control.

When the operation unit P4 shown in FIG. 3 is operated to set the schedule of external charging while the vehicle 10 is traveling, as indicated by lines L13, L23, a second PC control (S66) for heating the battery 100 to T3 or a second PC control (S68) for cooling the battery 100 to T6 is executed. As a result, the temperature of the battery 100 can be set within the recommended temperature range at the start of external charging until the start of external charging.

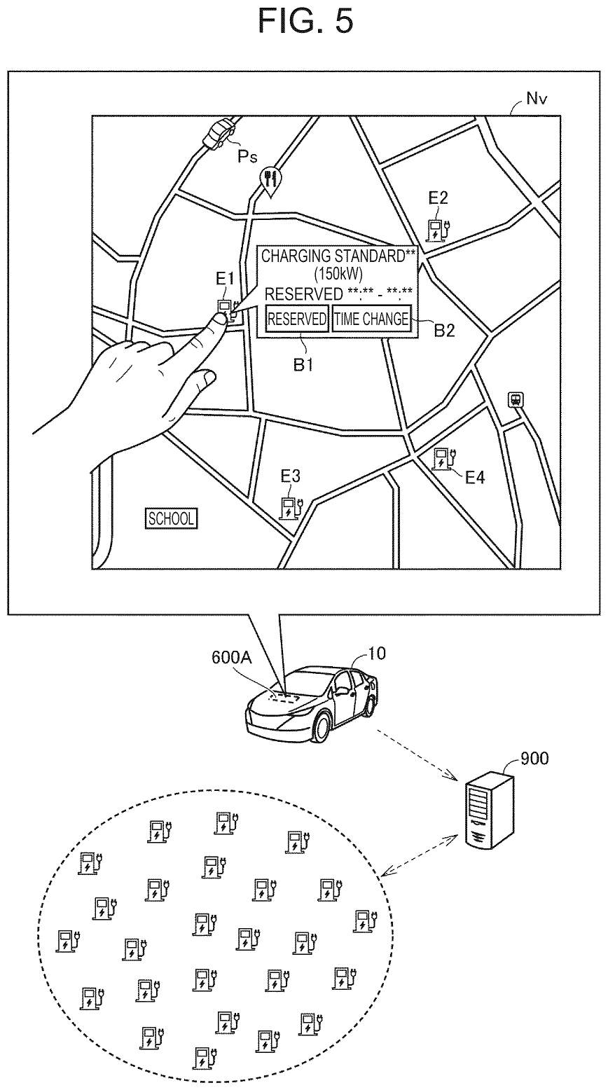

The user may set the external charging schedule using the HMI 600A instead of the mobile-terminal 600B. HMI 600A may function as a navigational system. FIG. 5 is a diagram illustrating a modification of a method of inputting a schedule of external charging. Referring to FIG. 5, HMI 600A displays a display Nv for car navigation, for example. The mark Ps in the display Nv indicates the present position of the vehicle 10. Marks E1 to E4 in the display Nv indicate the position of EVSE for the path charge. When the user designates one mark from E4 from the mark E1 by operating the touch panel, a time zone that can be reserved, a reservation button B1, and a time change button B2 are displayed together with the information (charge standard, rated output, and the like) of EVSE corresponding to the designated mark. The user can change the displayed time zone by operating the time change button B2. Further, the user can make a reservation of the corresponding EVSE for the displayed time zone by operating the reservation button B1. When EVSE is reserved, the process shown in FIG. 2 is started, and it is determined that S11 is YES. In addition, the identification information (vehicle ID) of the vehicle 10 is transmitted from the vehicle 10 to the servers 900 together with the information of EVSE selected by the user. The servers 900 manage a plurality of EVSE including EVSE selected by the user. The vehicle 10 may perform vehicle authentication or user authentication with the reserved EVSE to external charging the battery 100 (e.g., rapid charge by DC power supply) using EVSE during the reserved period.

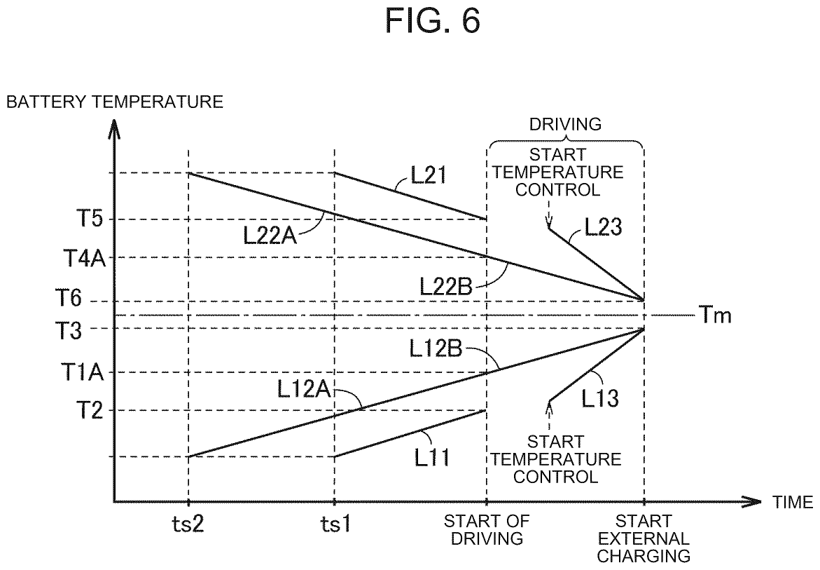

PC control condition-setting method is not limited to the above-described method. ECU 500 may have different timings for starting PC control between a case where external charging is scheduled and a case where external charging is not scheduled. For example, when the external charging by EVSE is reserved by the process illustrated in FIG. 5, ECU 500 may set PC control as described below. FIG. 6 is a diagram illustrating a modification of PC control condition-setting method. Referring to FIG. 6, ECU 500 may start the timing ts1 to start the first PC control when the external charging is not scheduled, and may start the first PC control at a timing ts2 earlier than the timing ts1 when the external charging is reserved. When the temperature of the battery 100 in the timing ts2 is lower than T3, the target temperature of the first PC control may be set so that the temperature of the battery 100 reaches T3 at or immediately before the reserved charging starting time. Instead of the above-described T1, a T1A corresponding to the reserved charge starting time may be set. Then, after the temperature of the battery 100 reaches T1A by the first PC control (line L12A) prior to starting the traveling, the battery 100 may be heated during the traveling of the vehicle 10 by the second PC control (line L12B). On the other hand, when the temperature of the battery 100 in the timing ts2 is higher than T6, the target temperature of the first PC control may be set so that the temperature of the battery 100 reaches T6 at or immediately before the reserved charging starting time. Instead of the above-described T4, a T4A corresponding to the reserved charge starting time may be set. Then, after the temperature of the battery 100 reaches T4A by the first PC control (line L22A) prior to starting the traveling, the battery 100 may be cooled by the second PC control (line L22B) during the traveling of the vehicle 10.

The vehicle is not limited to a passenger car, and may be a bus, a truck, or a work vehicle (a tractor, a forklift, or the like). The vehicle may be configured to be able to travel unmanned by automatic driving or remote driving. The vehicles may be automated guided vehicles (AGV). The number of wheels is not limited to four, and may be three or five or more wheels. The vehicle may be configured to be wirelessly chargeable.

The embodiments disclosed herein are to be considered in all respects as illustrative and not restrictive. It is intended that the scope of the disclosure be defined by the appended claims rather than the description of the embodiments described above, and that all changes within the meaning and range of equivalency of the claims be embraced therein.

What is claimed is:

1. A temperature adjustment system that comprises a control device, wherein:
the control device is configured to control a temperature adjustment device that adjusts a temperature of a power storage device mounted in a vehicle;
the control device is configured to acquire charging schedule information related to a schedule of external charging of the power storage device;
the control device is configured to execute a first precondition control that controls the temperature adjustment device such that a temperature of the power storage device is brought close to a target temperature before a start of traveling of the vehicle; and
the target temperature in the first precondition control is different when the external charging of the power storage device is scheduled and when the external charging of the power storage device is not scheduled.

2. The temperature adjustment system according to claim 1, wherein:
the vehicle is an electrified vehicle configured to be able to travel by using power output from the power storage device;
the temperature adjustment device is configured to adjust a temperature of the power storage device by using power output from the power storage device; and
in the first precondition control that cools the power storage device, the target temperature when the external charging of the power storage device is not scheduled is higher than the target temperature when the external charging of the power storage device is scheduled.

3. The temperature adjustment system according to claim 1, wherein in the first precondition control that heats the power storage device, the target temperature when the external charging of the power storage device is not scheduled is lower than the target temperature when the external charging of the power storage device is scheduled.

4. The temperature adjustment system according to claim 1, wherein:
the control device is configured to further acquire traveling schedule information that includes at least one of information related to a reservation of air conditioning of the vehicle and information related to a traveling start schedule time of the vehicle; and
the control device is configured to predict a traveling start time of the vehicle by using the traveling schedule information, and determine a start timing of the first precondition control by using the predicted traveling start time.

5. The temperature adjustment system according to claim 4, wherein:
the control device is configured to further execute a second precondition control that controls the temperature adjustment device such that a temperature of the power storage device is brought close to a target temperature during traveling of the vehicle and before a start of external charging of the power storage device;
the control device is configured to
set a first temperature to the target temperature in the first precondition control before a start of traveling of the vehicle, when the external charging of the power storage device is scheduled, and when the power storage device is heated in accordance with the first precondition control,
set a second temperature to the target temperature in the first precondition control before a start of traveling of the vehicle, when the vehicle schedules traveling, when the external charging of the power storage device is not scheduled, and when the power storage device is heated in accordance with the first precondition control,
set a third temperature to the target temperature in the second precondition control during traveling of the vehicle, when the external charging of the power storage device is scheduled, and when the power storage device is heated in accordance with the second precondition control,
set a fourth temperature to the target temperature in the first precondition control before a start of traveling of the vehicle, when the external charging of the power storage device is scheduled, and when the power storage device is cooled in accordance with the first precondition control,
set a fifth temperature to the target temperature in the first precondition control before a start of traveling of the vehicle, when the vehicle schedules traveling, when the external charging of the power storage device is not scheduled, and when the power storage device is cooled in accordance with the first precondition control, and
set a sixth temperature to the target temperature in the second precondition control during traveling of the vehicle, when the external charging of the power storage device is scheduled, and when the power storage device is cooled in accordance with the second precondition control;
the first temperature is higher than the second temperature;
the third temperature is higher than the first temperature;
the fifth temperature is higher than the fourth temperature; and
the fourth temperature is higher than the sixth temperature.
